(19) United States
(12) Patent Application Publication
(10) Pub. No.: US 2007/0004243 A1
(43) Pub. Date: Jan. 4, 2007

(54) Articulated structure and modules thereof

(76) Inventors: Martin Ferguson-Pell, London (GB); Graham Nicholson, London (GB); David Hawes, Uxbridge (GB); Karnik Tarverdi, Uxbridge (GB); Peter Allan, Uxbridge (GB); Mike Bevis, Uxbridge (GB)

Correspondence Address: NIXON & VANDERHYE, PC, 901 NORTH GLEBE ROAD, 11TH FLOOR, ARLINGTON, VA, 22203, US

(21) Appl. No.: 10/578,558

(22) PCT Filed: Nov. 5, 2004
(86) PCT No.: PCT/GB04/04710

§ 371 Date: May 28, 2006

(30) Foreign Application Priority Data
Nov. 6, 2003 (GB) 0325970.2

(51) Int. Cl. H01R 12/00

(52) U.S. Cl. 439/71

(57) ABSTRACT

There is disclosed a flexible sheet structure having improved conformability yet remaining strong and robust. The structure is made up of a plurality of modules that allow relative rotation in both an axis parallel to the plane and perpendicular to the plane of the sheet when laid flat. This allows the density of the sheet to be locally or globally changed so that improved conformability around complex shapes is provided. There is also disclosed a means for locking and unlocking the modules of the sheet using a locking material in each connection that is activated by the external addition of energy (e.g. heat energy).

The present invention relates to articulated structures, more preferably articulated sheet structures for use in a variety of applications. In particular, the invention relates to articulated structures comprising a plurality of modules connected together, each module being capable of rotating with respect to its neighbour. In another aspect, the invention relates to an articulated structure that may be selectively locked and unlocked.

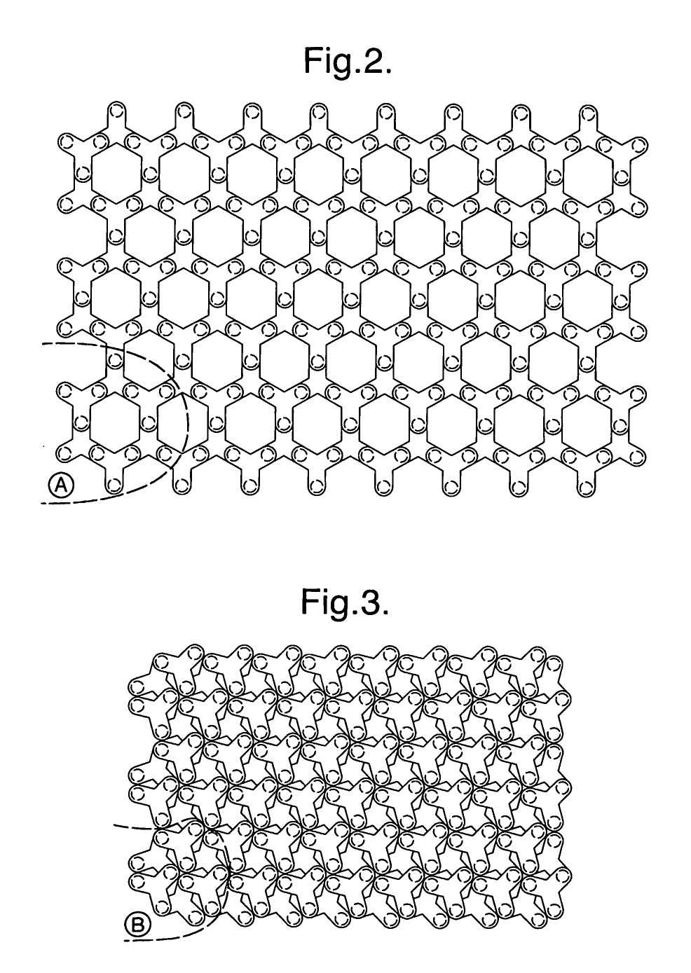

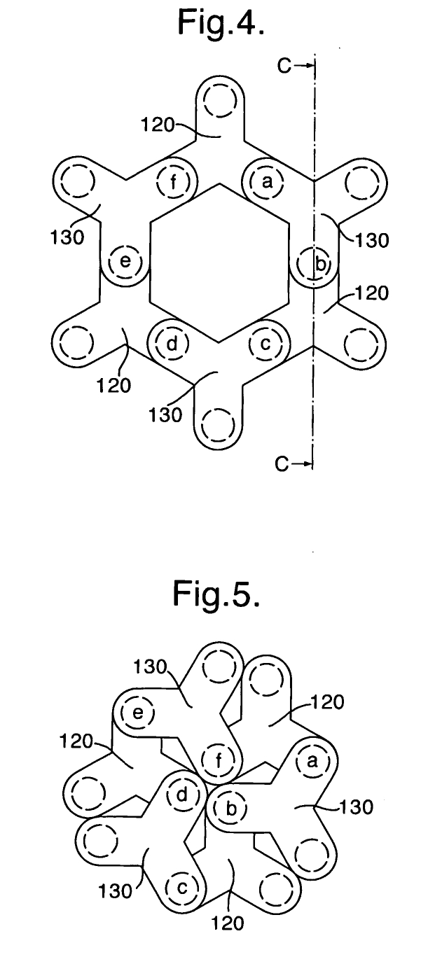

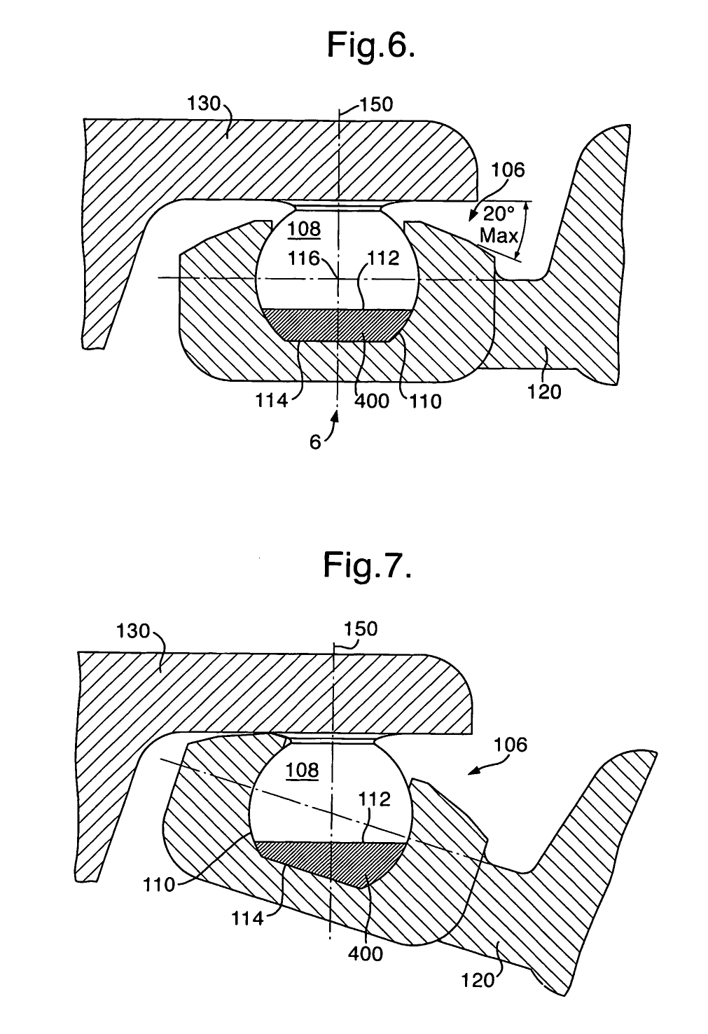

Articulated structures are known in the art. U.S. Pat. No. 4,484,778 discloses a matrix structure comprising a plurality of two differently shaped components. The first component, shown in FIGS. 2 and 6 of that document, has a central section surrounded by a plurality of spherical projections radiating from the central section. The second component, shown in FIGS. 4 and 7 of that document, has a central section with a corresponding plurality of radially disposed recesses. The spherical projections nest in the recesses in use such that a flat sheet-like structure can be produced in which the neutral axis of the spherical projection/recess joint is in the plane of the sheet, and passes through the centre of neighbouring modules. The form of the spherical projection and recesses is such that it is not possible substantially to change the density of the matrix sheet while keeping the sheet flat. This has the consequence that it is not possible to mould the sheet smoothly around complex shapes, for example compound curves which curve in two directions at the same time, e.g., spherical surfaces. If it is needed to produce a sheet having a complicated surface profile, it is necessary to remove or add modules in order to change the density of the sheet at localised positions so as to achieve the correct shape. The removal and adding of modules is time-consuming and requires a skilled technician.

U.S. Pat. No. 4,688,853 discloses an adjustable matrix sheet also having two different types of module. The first module provides a plurality of arms capable of gripping a cylinder from a direction perpendicular to the longitudinal axis of that cylinder. The second module comprises a plurality of cylinders arranged in a ring around the centre of the module. In use, each arm of the first module grips a cylinder of a neighbouring second module. Like the U.S.'778 structure, this construction does not allow the sheet to be conformed around complex shapes because it is not possible to change the density of the sheet while the sheet is flat. It is once again necessary to add or remove modules if localized density changes are required.

GB 2,235,030 discloses a sheet structure having a plurality of identically shaped modules that may slide towards or away from their immediate neighbours. No articulation is provided to accommodate out-of-plane bending of the sheet and in fact such bending is provided, if at all, by the inherent flexibility of the material used to make the modules. This feature makes the matrix difficult to conform around complicated shapes since the matrix can only bend out of plane by elastic deformation, resulting in a corresponding restoring force which tends to flatten the sheet when the conforming force is removed.

Each of the above three documents also discloses the selective locking and unlocking of the sheet structure. In all three cases this is achieved by tightening a screw on either the module or the connection between neighbouring modules. Thus, it is necessary to tighten a great many individual screws in order to transform a sheet from completely flexible to completely rigid. This has the disadvantage that it takes a skilled technician a very long time, especially when one considers that sheet structures may contain hundreds or even thousands of individual modules. Furthermore, it is necessary to find some means of holding the sheet in position for an extended period of time while the screw tightening procedure is carried out, which can require another technician or complicated clamping arrangement.

The present invention addresses the above and other problems by providing a flexible sheet structure comprising a plurality of modules connected together, said plurality of modules being connected together so that each module is capable of rotating about first and second axes with respect to a neighbouring module to which it is connected, said first axis being parallel to the plane of the sheet when laid flat and said second axis being orthogonal to the plane of the sheet when laid flat.

The fact that each module is capable of rotating about an axis parallel to the plane of the sheet when laid flat and an axis orthogonal to the plane of the sheet when laid flat allows a sheet structure that is usually flat to be conformed about a shape that curves in more than one direction (e.g. a spherical surface or other compound curve). This allows a standard sheet structure to be made and sold in a flat orientation and for the user to simply conform it to the desired shape, without the need to remove or add extra module sections.

Preferably a module can rotate relative to its neighbour about the axis parallel to the plane of the sheet when laid flat through at least the full range of −10° to +10°, more preferably the full range of −20° to +20°, but preferably by between no more than −60° and +60° or more preferably by between no more than −30° and +30°.

Preferably a module can rotate relative to its neighbour about the axis orthogonal to the plane of the sheet when laid flat through at least the full range of −10° to +10°, more preferably through the full range of −30° to +30° and more preferably still at least through the full range of −80° to +80°.

In a preferred embodiment, each module has a plurality of nodes and the modules on the inside of the sheet have each of their nodes connected to respective nodes of different neighbouring modules. The modules near the outside of the sheet may not have all of their nodes connected to the nodes of other modules. Three and only three nodes per module has been found to work well, as has four and only four nodes. However, a single structure may comprise combinations of modules having different numbers of nodes, and some 2, 5 or 6-noded modules can be utilised in this way.

The nodes are preferably located at the end of arms and the arms of the modules preferably lie parallel to the plane of the sheet when laid flat. The nodal connections between neighbouring joints are preferably single joints, such as ball and socket joints, that allow rotation orthogonal to the plane of the sheet and parallel to the plane of the sheet, preferably simultaneously.

It has been found advantageous that said single joint has a neutral axis (that is to say the joint is centred with respect to its possible rotation) oriented at substantially 90° to the plane of the sheet when laid flat. This is not essential, however, and the neutral axis may be substantially parallel to the plane of the sheet when laid flat or at a different angle to the plane of the sheet.

In one embodiment of the invention, linking components are used to connect neighbouring modules together. A linking component may allow relative rotation between the module and the linking component about an axis parallel to the plane of the sheet and may allow relative rotation between an adjacent other linking component about an axis orthogonal to the plane of the sheet. In this case, the sheet comprises two different types of joints, one parallel to the plane of the sheet and one orthogonal to the plane of the sheet. This is an alternative to the first embodiment wherein all movements are provided for by a single ball/socket joint. The linking component is preferably a linear component having 2 nodes.

In all embodiments, the modules are preferably connected together to form a regular pattern of closed loops in the plane of the sheet. These closed loops can provide the means for changing the density of the sheet in a localized area as modules contributing to the perimeter of any loop can rotate about an axis orthogonal to the plane of the sheet when laid flat in order to close the loop up into a “star” or otherwise closed shape.

Preferably the effective density (and thus the area, since mass remains conserved) of the whole or part of the sheet can be varied while the sheet remains flat. This, however, is not limiting and the effective area of the whole or part of the sheet may also be varied while the sheet is contorted into any particular shape. It is to be noted that an increase in localized effective area while flat results in a bowing of the sheet out from the flat whereas a decrease in localized effective area while bowed results in a flattening of the sheet from a bowed position. The ability to change the effective area in localized positions allows the sheet to conform over an object in a similar manner to a rubbery substance, but does not have the disadvantage of rubber, which must be elastically deformed, causing an undesirable restoring force. The sheet according to the preferred embodiment can be deformed to take on a particular shape yet will be in a position of static equilibrium (i.e. there will be no restoring forces tending to bring the sheet back to its original shape).

In another aspect, the present invention may be described as a flexible sheet structure comprising a plurality of modules connected together, at least one of said modules being connected to another said module by a multiple degree of freedom joint that has a neutral axis oriented substantially at 90° to the plane of the sheet when laid flat.

As well as being at substantially at 90° to the plane of the sheet when laid flat, the ball/socket joint is preferably also oriented with its neutral axis at substantially 90° to the plane of each module. Preferably all of the connections in the sheet are of the type having their neutral axes oriented at substantially 90° to the plane of the sheet and/or module when laid flat.

Another embodiment of the invention provides a flexible sheet structure comprising a plurality of first and second connected components, each said first component being connected to a said second component by a joint that allows for relative rotation about an axis parallel to the plane of the sheet when flat and each said second component being connected to a neighbouring said second component by a joint that allows for relative rotation about an axis orthogonal to the plane of the sheet when flat.

This construction allows the sheet structure to be conformed into complicated shapes without the need for adding or removing individual modules. It also has the advantage of not requiring ball/socket joints. All joints can be created using simple pivots.

Another preferred embodiment of the invention provides a flexible sheet structure comprising a plurality of modules connected together, each of said modules having first, second and third arms, each of said arms being regularly spaced from the other two said arms, each said arm being connected to an arm of a neighbouring said module so that each module of the sheet is capable of rotating with respect to its neighbouring module about an axis orthogonal to the plane of the sheet when laid flat.

The present invention also provides a flexible street structure comprising a plurality of modules connected together, said plurality of modules being connected together so as to allow the effective area of the sheet to be varied while the sheet remains flat and to allow out of plane movement so that the sheet may be smoothly conformed around complex shapes.

The present invention is also intended to encompass any one of the modules described herein, which modules may be made and sold separately, perhaps in kit form. A particularly preferred such module is a module for use in a flexible sheet structure, said module having arms each comprising one half of a multiple degree of freedom joint, for connection with the other half of the multiple degree of freedom joint located on an arm of a neighbouring module in the sheet, said multiple degree of freedom joint half being oriented such that the resulting multiple degree of freedom joint will have a neutral axis oriented out of the plane of the sheet when flat.

In order to address the problem of burdensome and tricky manual tightening of each module of the prior art structures, another aspect of the present invention provides A lockable articulated structure comprising a plurality of modules connected together so that said modules are selectively moveable with respect to one another, at least one connection between two said modules comprising a locking material capable of assuming at least two states, said at least two states including a first state which allows relative movement of said components and a second state which at least substantially prevents such movement, a transition between said two states being accomplished by the selective introduction of energy to said locking material.

The use of a locking material capable of assuming at least two states, with a transition (either locked to unlocked or unlocked to locked) between the two states being accomplished by the selective introduction of energy to the locking material, allows, if desired, each of the connections between neighbouring modules in the whole structure to be selectively locked or unlocked upon a single application of a particular form of energy. For example, the locking material can be one which melts and/or becomes soft when heated. In this case simple heating of the entire structure will be enough to cause the transition from the locked to the unlocked state. It follows that the structure will become locked in position upon simple cooling of the structure, although it is not necessary to the invention for the transition to be reversible.

Preferably the first state is a softer state than the second state, the second state being a frozen state for example. The application of energy could be in the form of heat, for example by direct conduction, convection or radiation or by the application of microwave or similar energy that is designed to excite or modify the physical properties of the locking material but not other parts of the module. Instead of the material changing, or starting to change, its phase, the selective locking may be accomplished by the fact that the material has a particular coefficient of thermal expansion. In this case heating up the structure will cause the locking material to expand so as to prevent relative movement that would otherwise be able to occur between neighbouring modules. The expansion may be provided by heat or by any other source of energy, for example by electricity in an electro-rheological material or piezoelectric material.

Another possibility is for the energy provided to cause a curing, for example ultra-violet light which may cure a chemical composition from a non-adhered state to an adhered state.

Another mechanism that may be used is the selective introduction of fluid pressure, for example pneumatic or hydraulic pressure, which pressure may either pressurize or depressurize the locking material so as to provide or prevent a locking function.

For ball/socket embodiments, the locking material is ideally located in the region outside of the ball but inside of the socket in the ball/socket joint. In order to improve the locking ability, either the outside of the ball or the inside of the socket may have substantially flat portions such that relative rotation is resisted when the locking material is not able to change its shape. To improve locking ability still further, one or more grooves may be provided, preferably in a direction running from the base of the ball to the tip of the ball so as to prevent axial rotation about the neutral axis. It is not essential to use grooves—any surface topography which serves to inhibit relative rotation when the locking material is frozen will be adequate.

The same considerations apply when the joint is a pivot or other type of joint rather than a ball/socket joint. For a pivot joint, the locking material can be located between a shaft part and an annular part and similar flats or grooved portions may be used further to inhibit relative movement once the transition to a locked state has taken place.

Thermoplastic, eutectic and thermosetting materials are all suitable as embodiments of the locking material, although other material may work at least as well. In particular, polymers are a good candidate because they are easy to make and have the desired qualities.

It will be appreciated that any of the herein described methods of, and structures for, selective locking may be combined with any of the embodiments of articulated structure so that the herein described articulated structures may be selectively locked.

The present invention is particularly useful when applied to a spinal brace. The ability of the articulated structure to conform around complicated shapes allows a spinal brace to be created that conforms to the desired body shape, but which is made from an initially flat piece of material. It is not necessary for the orthotic surgical technician to remove or add modules when fitting the brace and the locking mechanism allows the whole brace to be locked or unlocked very quickly and in one operation. As an example of a brace fitting routine, the sheet structure may be initially subjected to microwaves to make it unlocked. This will not unduly raise the temperature of the modules themselves so that the sheet, while loose, may be conformed around the body of the patient to provide the desired support. The locking material will cool down over time, either naturally or with the help of applied artificial cooling, such that the sheet only needs to be held in position for a short amount of time before it is once again locked. The present invention therefore significantly improves the creating and fitting of the brace from both the point of view of the patient and medical professional.

Embodiments of the present invention will now be described, by way of example only, with reference to the accompanying drawings, in which:—

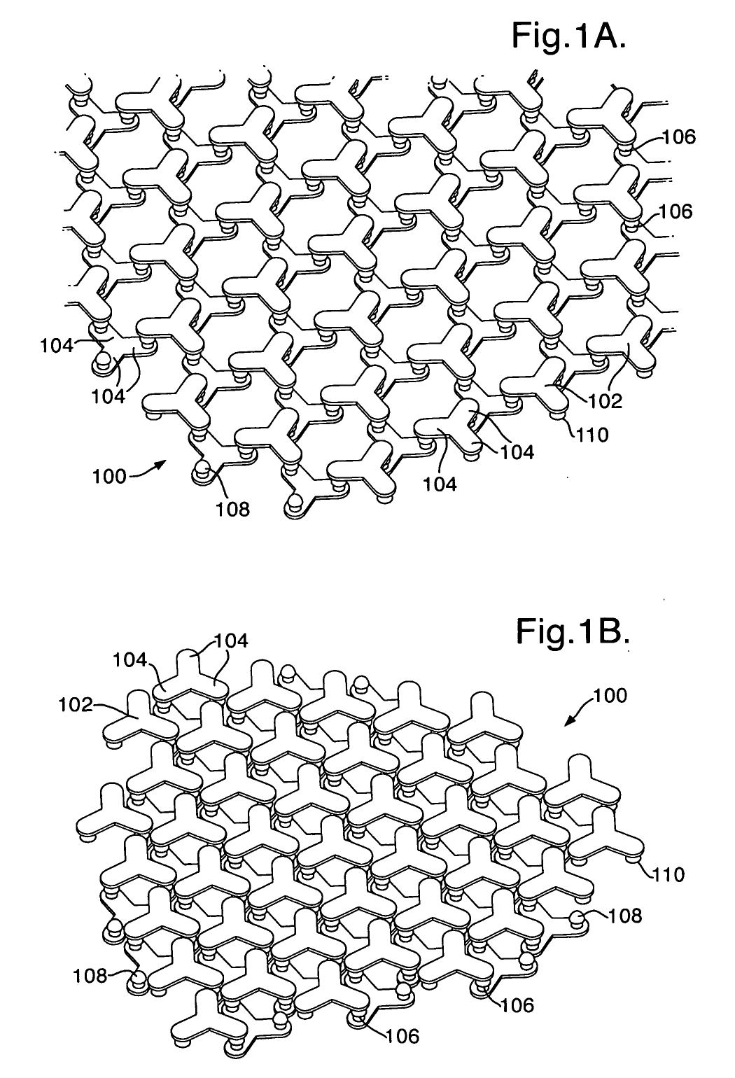

FIG. 1A shows a perspective view of part of a sheet of modules in an expanded configuration according to the first embodiment of the present invention;

FIG. 1B shows a perspective view of part of a sheet of modules in a contracted configuration according to the first embodiment of the present invention;

FIG. 2 shows a plan view of a sheet according to the first embodiment, in a configuration where the sheet structure is most expanded within its plane;

FIG. 3 shows an alternative plan view of a sheet according to the first embodiment, in a configuration where the sheet structure is most compressed within its plane;

FIG. 4 shows a plan view of six modules of the first embodiment, showing the preferred hexagonal ring structure;

FIG. 5 shows the modules of FIG. 4, but rotated so as to increase overall density and close up the ring structure;

FIG. 6 shows a cross-sectional view along the line C-C shown in FIG. 4 when modules 120 and 130 are neutrally disposed with respect to an axis within the plane of the flexible sheet;

FIG. 7 shows a cross-sectional view similar to that of FIG. 6, but when module 120 has been rotated about an axis that is within the plane of the flexible sheet and is perpendicular to the page;

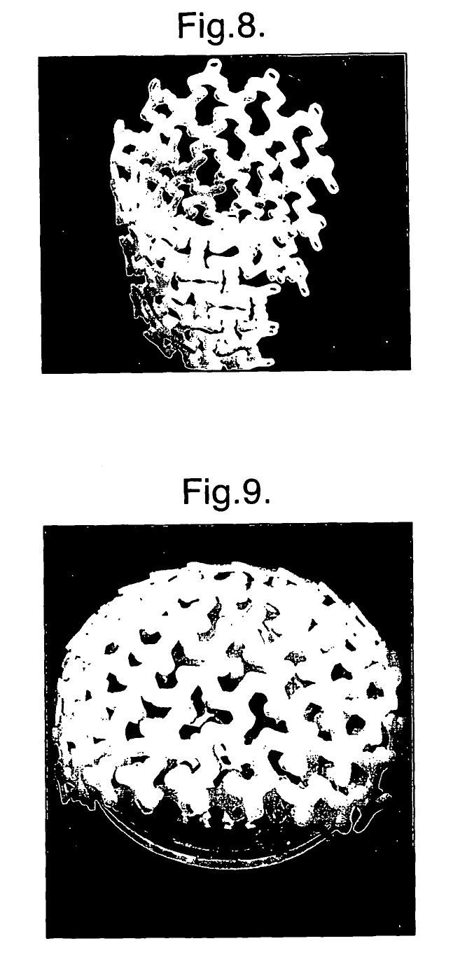

FIG. 8 shows the flexible sheet of the first embodiment conformed around the surface of a cylinder;

FIG. 9 shows the flexible sheet of the first embodiment conformed around the surface of a hemisphere;

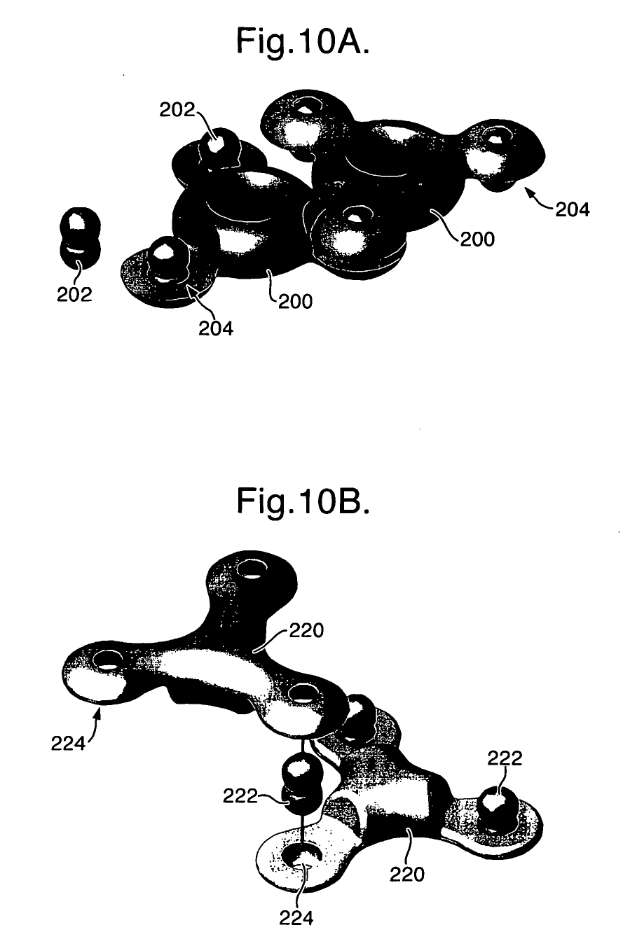

FIGS. 10A and 10B show two configurations of two modules of a second embodiment of the invention;

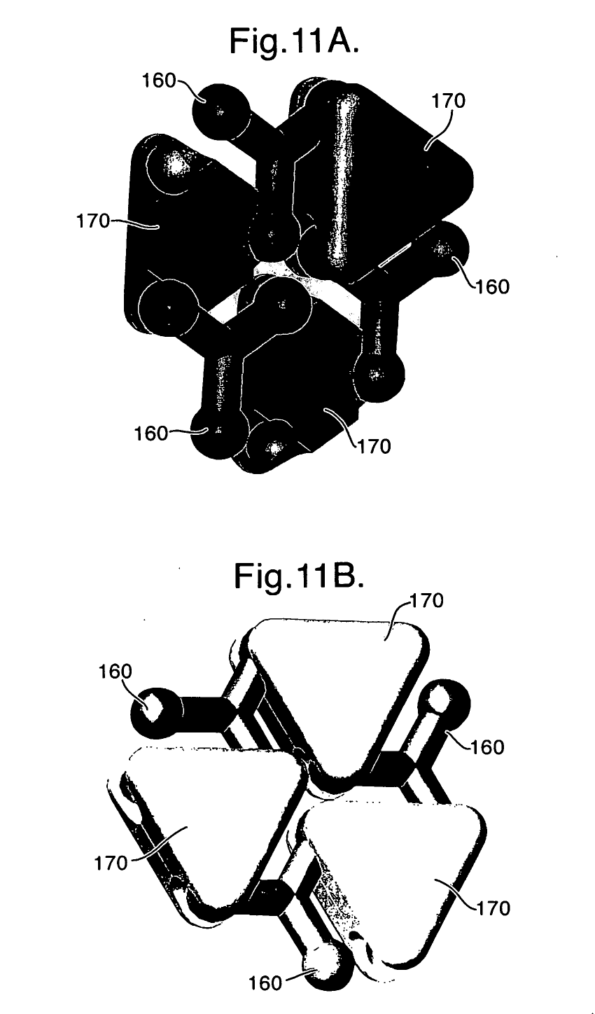

FIGS. 11A and 11B each show six modules of a third embodiment of the invention;

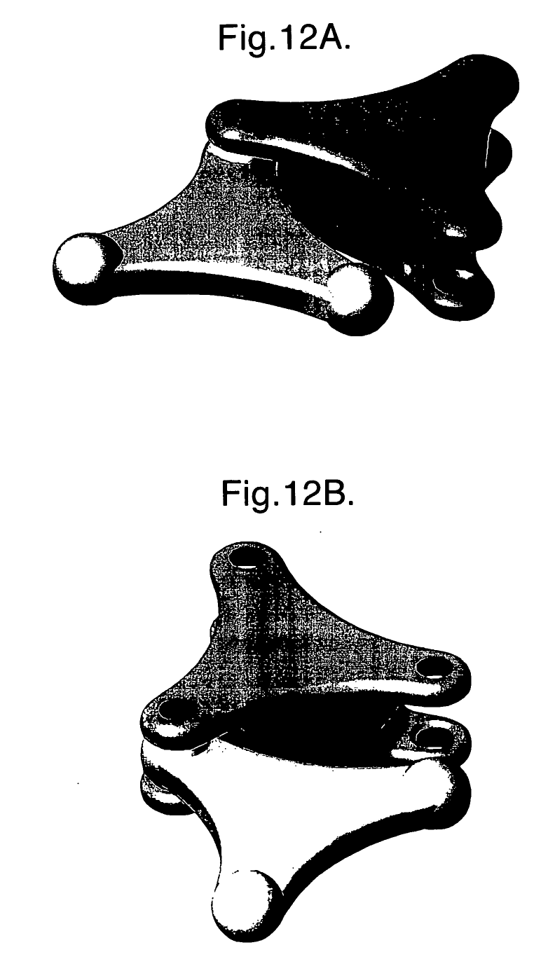

FIGS. 12A and 12B show two configurations of two modules of a fourth embodiment of the invention;

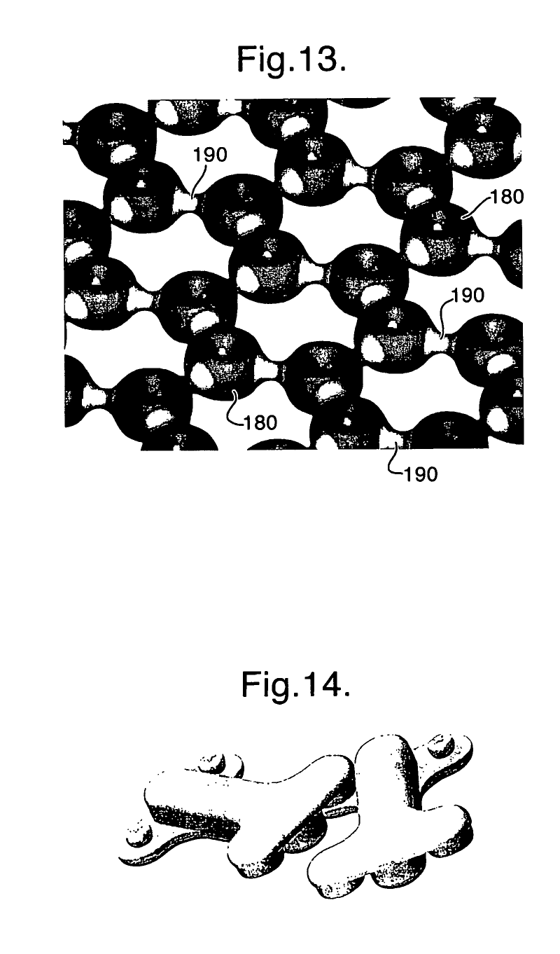

FIG. 13 is a perspective view of a fifth embodiment of the invention;

FIG. 14 is a perspective view of two modules of a sixth embodiment of the invention;

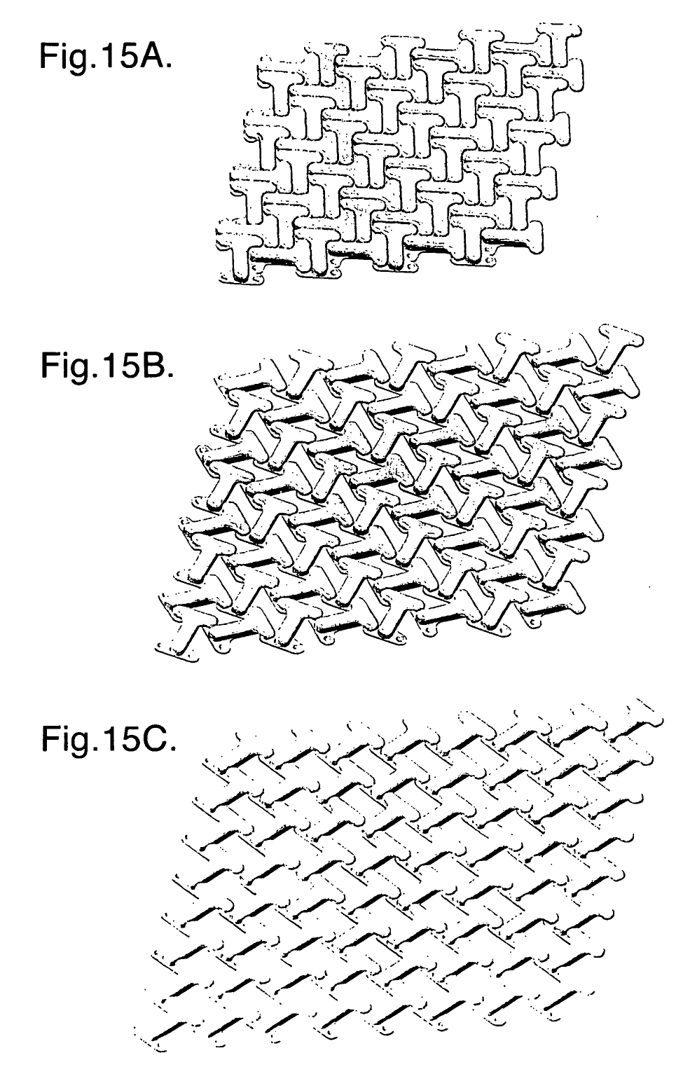

FIGS. 15A to 15C show a sheet comprising modules of the sixth embodiment of the invention as it expands from its closed state to its open state

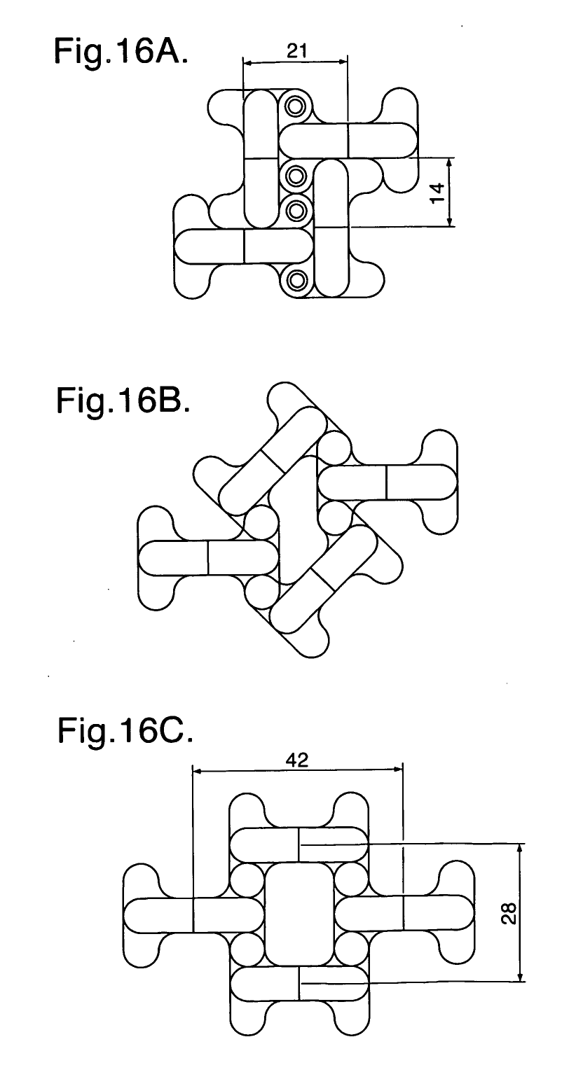

FIGS. 16A to 16C show four modules of the sixth embodiment of the present invention and illustrates how the sheet expands from its closed state to its open state to provide an expansion of 200%;

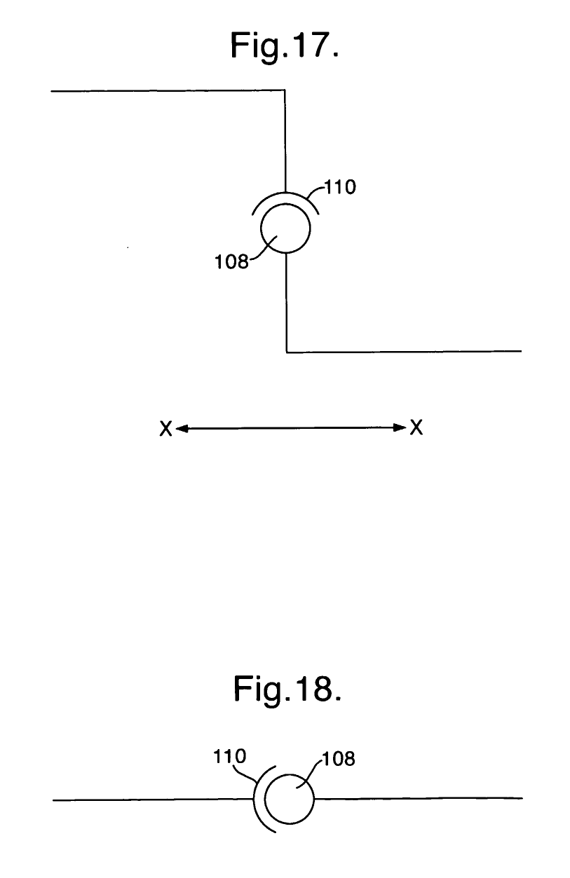

FIG. 17 schematically shows a neutral axis disposed perpendicular to the plane of the flexible sheet;

FIG. 18 schematically shows a neutral axis disposed parallel to the plane of the flexible sheet; and

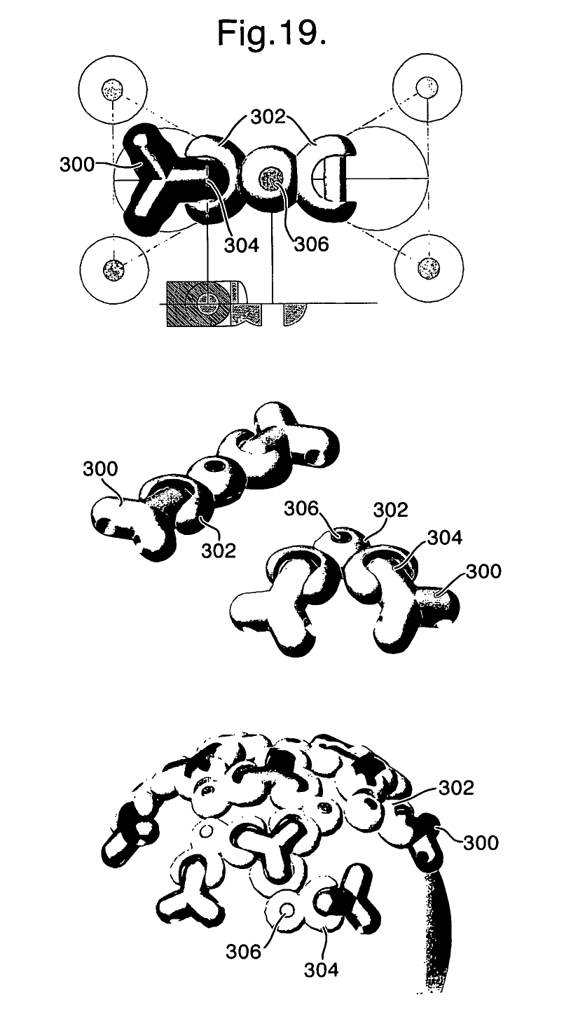

FIG. 19 shows a seventh embodiment of the invention.

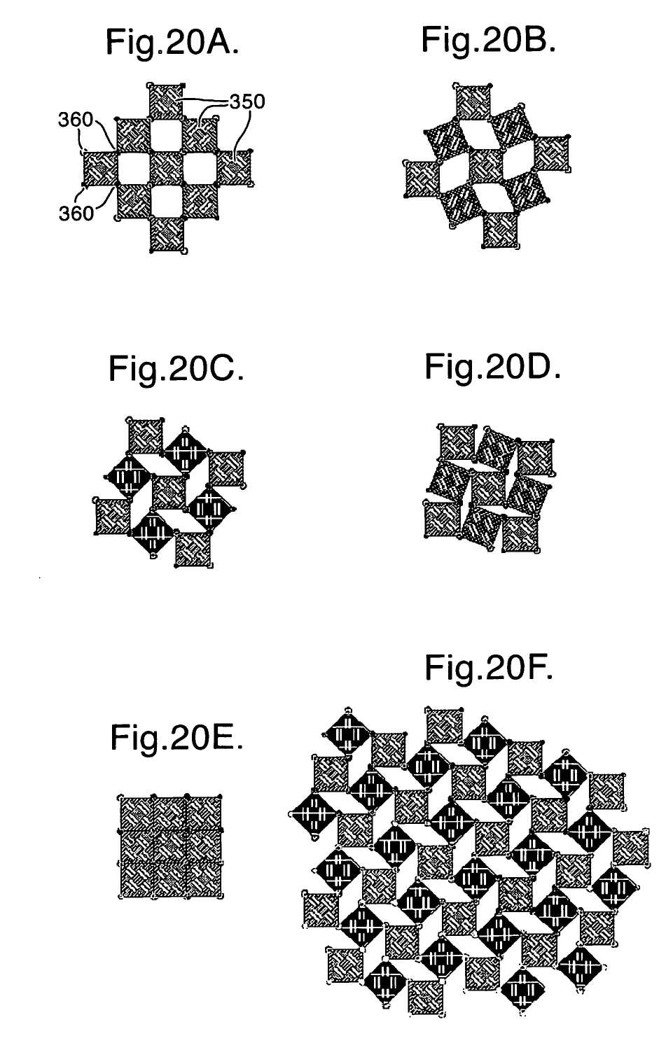

FIGS. 20A to 20F schematically show a sheet structure using only 4 nodes for each module;

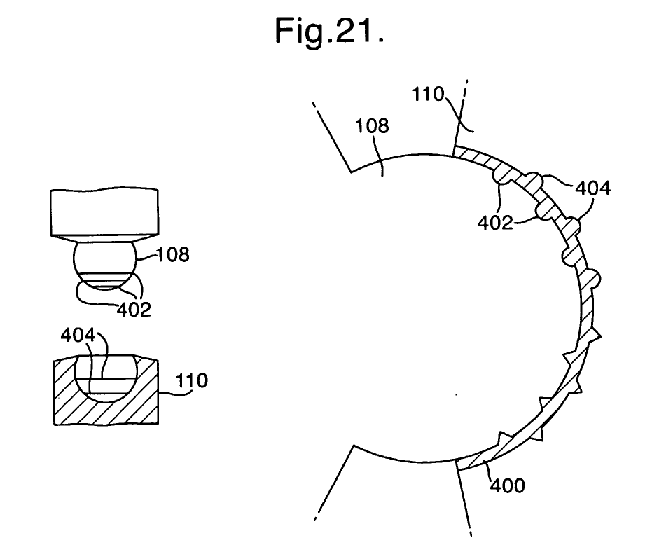

FIG. 21 shows a cross-sectional view through a ball according to an embodiment of the invention;

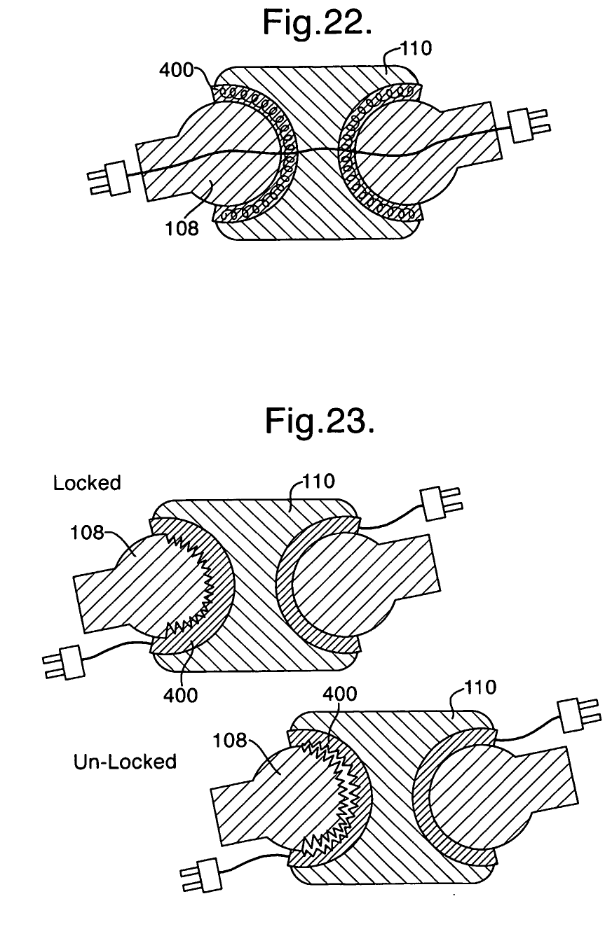

FIG. 22 shows a cross-sectional view through a module comprising two sockets, each socket having a ball therein according to an embodiment of the invention;

FIG. 23 shows a cross-sectional view through a module comprising two sockets, each socket having a ball therein according to an embodiment of the invention;

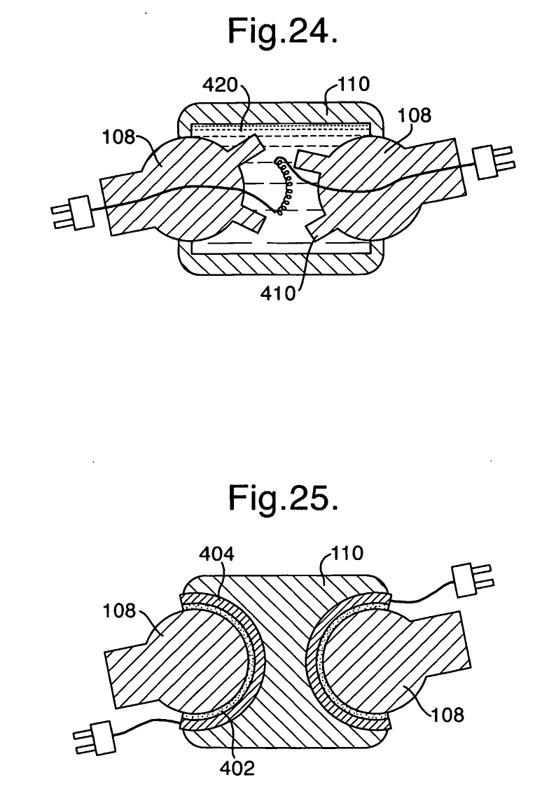

FIG. 24 shows a cross-sectional view through a module comprising two sockets, each socket having a ball therein according to an embodiment of the invention;

FIG. 25 shows a cross-sectional view through a module comprising two sockets, each socket having a ball therein according to an embodiment of the invention;

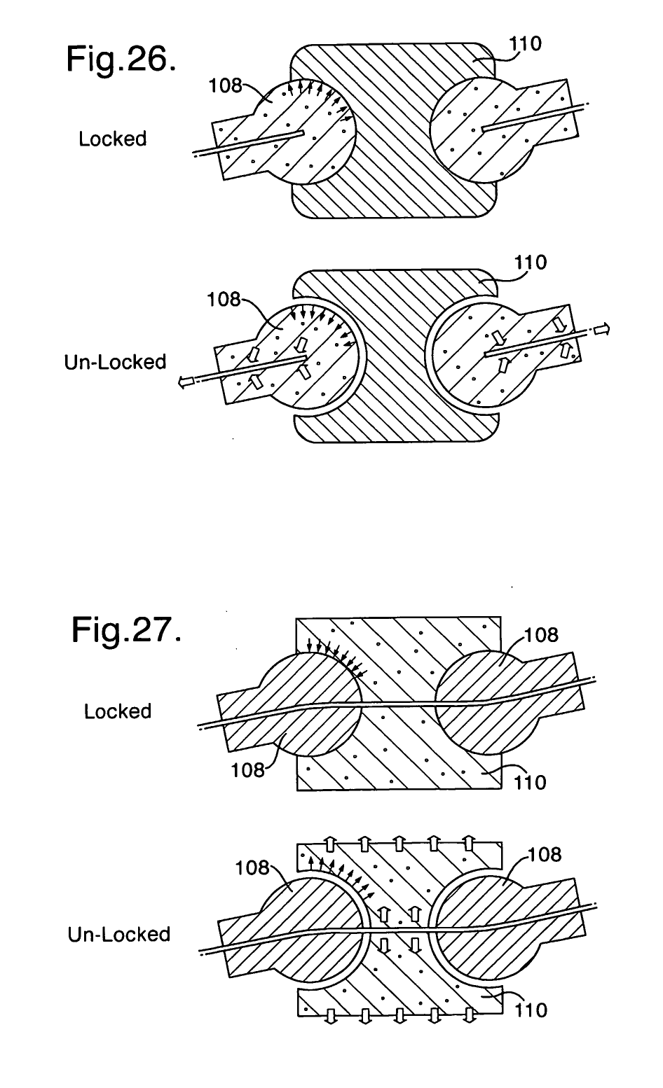

FIG. 26 shows a cross-sectional view through a module comprising two sockets, each socket having a ball therein according to an embodiment of the invention;

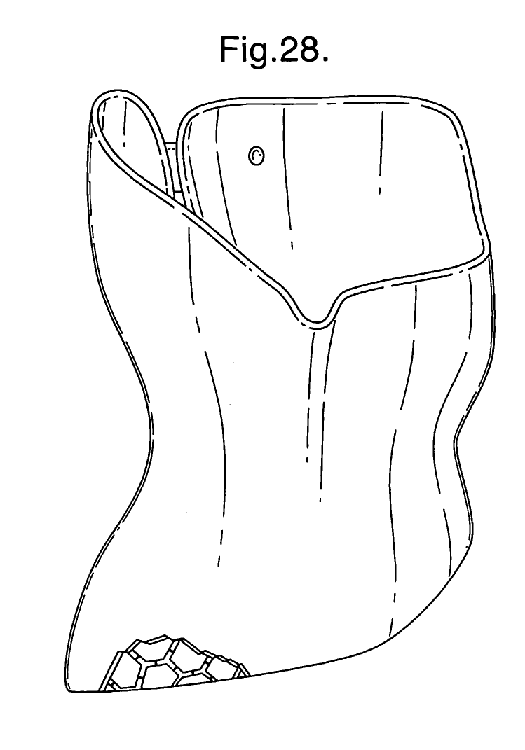

FIG. 27 shows a cross-sectional view through a module comprising two sockets, each socket having a ball therein according to an embodiment of the invention; and

FIG. 28 shows a flexible sheet according to the present invention moulded into the shape of a spinal brace and covered with a skin material.

FIGS. 1A and 1B are perspective views of a first embodiment of the present invention. FIG. 1A shows the structure in a flat, expanded form and FIG. 1B shows the structure in a flat, compressed form. As can be seen, the sheet structure 100 comprises a plurality of modules 102, each module having three equispaced arms 104 (i.e. arranged at 120° intervals in the same plane) and having at the end of each arm one half of a ball and socket joint 106. All of the modules are the same shape and all seem to be visually identical at first sight. However, there are actually two distinct types of module in the sheet; a first type carrying a ball half of the ball/socket joint 106 at the end of each arm, and a second type carrying a socket half of the ball/socket joint 106 at the end of each arm. This is for manufacturing convenience only and it is not important to the invention that each module carries only one type of ball/socket joint half.

The modules of the sheets are preferably arranged in a regular pattern as is shown in the plan view (i.e. the plane of the sheet is parallel to the plane of the page) of FIG. 2. As can be seen, each arm 104 of each module 102 is connected to an arm 104 of a neighbouring module 102. Because each module 102 has three arms 104, each module 102 usually has three neighbouring modules. As shown in FIGS. 1A and 2, each arm of each module is parallel to the connecting arm of each neighbouring module and this leads to the flexible sheet being in its most expanded configuration. In this embodiment, the connection is such that connecting modules are not in the same plane and each module is in a different plane to its three nearest neighbours. There are thus two separated planes of modules. This is perhaps best seen in FIGS. 1A and 1B. The two planes containing the two sets of modules are spaced apart by the length of connection 106, which is about 6 mm in this embodiment. The connections are preferably ball/socket joints having their neutral axis in a direction perpendicular to the page (and thus also perpendicular to the two planes of modules while the sheet remains flat). The “neutral axis” of the ball/socket joint is defined as that axis at which the ball is centred in the socket. Thus, the neutral axis is the centre of the whole range of movement for the ball/socket joint. This is explained in more detail later with reference to FIGS. 14 and 15.

The configuration shown in FIGS. 1A and 2 depicts the sheet in its most “stretched” or expanded position. In other words, this position is the one in which the density of the sheet is lowest (this can be confirmed visually by noting that there are a number of open hexagonal “rings” in the sheet).

In use, the sheet, or just part of it, may be increased in density while remaining flat by rotating some of the ball/socket joints about an axes orthogonal to the plane of the sheet, that is to say about their neutral axes. FIGS. 1B and 3 show the result of such rotations in the case that all of the modules are rotated with respect to their neighbours about (and only about) an axis orthogonal to the plane of the sheet. As can be seen, the overall density of the sheet is greatly increased (and thus the overall area of the sheet is greatly reduced). The geometry of the present embodiment gives a reduction in area such that the area of the sheet when most compressed is about 70% of the area of the same sheet when most expanded.

FIGS. 4 and 5 show a close-up of the area highlighted as “A” in FIG. 2 and “B” in FIG. 3 respectively. These Figures serve to explain the mechanism of the density reduction in more detail.

A single “ring” of the structure is shown in FIG. 4. The “ring” is actually hexagonal due to the fact it is delimited by six modules each having three equi-spaced arms. Modules referenced 120 are in a different plane to modules referenced 130. As discussed above, these two planes are parallel when the flexible sheet is laid flat. In the formation shown in FIG. 4, the centroid of each module is located the maximum possible distance away from the centroid of each of the other modules in the sheet. No module can be further separated from any other module and it follows that the sheet is at its point of lowest density.

If one considers the nodal connection points a, b, c, d, e, f shown in FIGS. 4 and 5, it can be seen that the increase in density is achieved by bringing the nodal connection points b, d, f in towards the centre of the “ring”. The position of the remaining nodal connections a, c, e remains relatively static during this movement, as shown in FIG. 5. It will therefore be seen that the modules are capable of rotating so as to “close-in” to occupy the space in the centre of the ring that was previously unoccupied.

The above-discussed relative movement of adjacent modules about an axis orthogonal to the plane of the sheet when laid flat so as to reduce the density of the whole or a part of the sheet is just one movement that this embodiment of flexible sheet is capable of undergoing. The ball/socket joint 106 of this embodiment is also capable of allowing relative movement between modules about any axis parallel to the plane of the sheet.

FIGS. 6 and 7 show two cross-sectional views of the ball/socket joint 106, as viewed on the line C-C shown in FIG. 4. As can be seen, the ball 108 locates in the socket 110 so that it cannot escape by vertical pulling. The ball can rotate about the neutral axis 150 of the ball/socket joint (so as to give the above-discussed rotation about an axis orthogonal to the plane of the sheet) and the ball can also rotate in the socket about other axes.

In FIG. 6, the ball and socket joint is in its “neutral” state. It can be seen that the joint is formed so as to allow an equal amount of rotation (about 20° in this case) about any axis parallel to the plane of the sheet.

It will be appreciated that the ball 108 is not completely spherical and is partially cut-away to leave a substantial flat portion 112 at its base. Similarly, the socket 110 is partially filled in to leave a substantial flat portion 114 at its base, although this flat 114 is not as close to the centre 116 of the ball 108 as the flat 112 of the ball. These flat portions 112/114 are optional and need not be provided. They may assist, however, when the structure is to be locked, as will be later described. The term “ball/socket joint” is intended to cover sockets as illustrated in FIGS. 6 and 7 having flat portions, as well as traditional sockets where the engaging parts of the ball and socket are spherical, and in fact any socket in which one part performs the function of the ball and another part performs the function of a socket. In all embodiments, any multiple (e.g. 2, 3 or more) degree of freedom joint may be used, of which a ball/socket joint is one example.

FIG. 7 shows the position of the modules after the module 120 has been rotated with respect to module 130 about an axis perpendicular to the page (i.e. an axis parallel to the plane of the sheet of the flexible structure). It can be seen that module 120 is able to rotate by about 20° around this axis. Similarly, rotation in the other direction about the same axis is possible to a maximum extent of about 20°. This has been found to be adequate to allow conformation around complex shapes without compromising the mechanical strength of the joint.

This movement about an axis parallel to the plane of the sheet allows the sheet to be bent around simple shapes such as cylinders, as shown in FIG. 8. In FIG. 8, only one degree of freedom of the ball/socket joint has been used to achieve conformation about the cylinder surface and conformation around simple shapes such as this is generally achievable by modules rotating relative to one another solely about an axis in the plane of the sheet.

The present embodiment finds most utility, however, when it is used to conform around complicated shapes, for example, the body shape of a patient requiring a spinal brace. In the case when it is desired to conform the sheet around a complex shape, more degrees of freedom of the joint are used simultaneously and in particular rotation about an axis orthogonal to the plane of the sheet is carried out simultaneously to rotation about an axis parallel to the plane of the sheet.

FIG. 9 shows a sheet according to the first embodiment conformed around the surface of a hemisphere. It will be appreciated that this has been achieved pressing the initially flat sheet of FIG. 3 around the hemisphere. In so pressing the density of the sheet in the middle of the sheet (i.e. at the top of FIG. 9) is locally reduced whereas the density near the outer edges of the sheet (towards the bottom of FIG. 9) remains high. Thus, FIG. 9 gives an example of a localised change in density of the sheet which has allowed it to conform around a complex shape.

The modules of this embodiment are preferably manufactured from injection moulded plastic. Any suitable plastics material may be used and polyamide (Nylon) and polycarbonate have been found to perform adequately.

Each module can be made from a flat tri-armed plastic member, as shown in FIGS. 1 and 2. The thickness of the member can be any suitable value, e.g. 0.1 to 5 mm although a thickness of about 2 mm has been found to give a good compromise between strength, lightness and conformability. The length of each arm 104 from the centre of the module to the centre of rotation of the ball/socket joint at the end of the arm can also take any suitable value, e.g. 5 to 50 mm. An 8 mm arm length has been found to allow the structure to articulate around most practical shapes. As is shown in FIGS. 1 and 2, the arms can have a constant width along their length and may be rounded at their terminating ends for safety reasons (to prevent sharp comers) and to allow the structure to close up more tightly (as shown in FIG. 3). This width can take any suitable value, e.g. 2 to 20 mm and 7 mm has been found to perform well. Thus, the structure shown in FIG. 1 advantageously has a module thickness of 2 mm, an arm width of 7 mm and an arm length (i.e. distance from the centre of the module to the centre of rotation of the joint) of 8 mm. The two “layers” of modules 120, 130 can be separated (centre to centre) by an amount that is selected to define the overall thickness of the sheet structure, for example a separation of 8 mm will give an overall thickness of 10 mm when 2 mm thick modules are used. When each of the planar modules are 2 mm thick, a separation of the two layers of 8 mm can be achieved by selecting ball/socket joints that have a longitudinal length (i.e. a length in the direction of the neutral axis) of 6 mm. The balls of the ball/socket joint can have any suitable diameter, e.g. 1 to 10 mm. The balls shown in FIG. 1 have a diameter of 3 mm.

Each module 102 can be injection moulded in plastic such that the ball or socket half of the ball/socket joint is integral with the planar part of the module. In this case, two types of module can be manufactured; a first module having three socket joints and a second module having three ball joints. In this case, (as is shown in FIGS. 1 and 4) the first module 120 makes up one “layer” of the sheet and the second module 130 makes up the other “layer” of the sheet.

Alternatively, many similar modules can be manufactured separately from the two halves of the ball/socket and the appropriate ball/socket joint half can be glued or otherwise adhered to the standard planar module member.

FIGS. 10A and 10B show a second embodiment of module 200, 220 in which, instead of there being a single ball/socket joint for each arm of a module, two such ball/socket joints are provided by using a double ended ball linking piece 202, 222 and by providing the end of each module arm with a communicating socket 204, 224. This allows all the modules 202 to be manufactured identically, increasing efficiency of manufacture. This embodiment will also theoretically allow even more movement (i.e. greater than 20° in either direction) about axes parallel to the plane of the sheet without compromising mechanical strength. The mechanism of movement is for practical purposes substantially as described for the first embodiment.

Two alternative module shapes are shown in FIG. 10. In FIG. 10A, the centre of the module comprises a hollow ring structure. This maximises strength whilst reducing weight. FIG. 10B shows a more slender module. Each type of module can be used exclusively in a single sheet or the different modules can be used together in the same sheet. In both cases, the modules have rounded and smoothed edges to facilitate handling.

A third embodiment is shown in FIGS. 11A and 11B. The movement of the modules of the flexible sheet in this embodiment is substantially the same as the movement of the modules in the first and second embodiments. However, in this embodiment there are two quite distinctly different modules; a first module 160 having three equispaced arms and a ball member located at the end of each arm; and a second module 170 of triangular formation that is composed of two parallel plates joined at the centre (e.g. by screws or adhesive) and which grip the balls of the first module 160 at the corners. The gripping is such as to allow relative rotation between the first and second modules both about an axis orthogonal to the plane of the sheet and about an axis parallel to the plane of the sheet. It will be seen from FIG. 11 that module 160 can move with respect to module 170 through about 180° about an axis orthogonal to the plane of the sheet. The diameter of the balls compared to the thickness of the arms dictates the amount of movement achievable about axes parallel to the plane of the sheet. Preferably at least 10° of rotation in either direction is possible, and preferably no more than 60° in either direction is allowed, so as to maintain the structural strength of the arms, which should not be too thin. This embodiment has the advantage that it better simulates a continuous surface, thanks to the solid triangular modules 170. It will also be seen that the “neutral axis” of the ball/socket joints lies in the plane of the flexible sheet when it is laid flat. This is discussed in more detail later.

FIGS. 12A and 12B show a fourth embodiment that is generally similar in construction to that of FIG. 11. In this embodiment, however, the two modules have a similar shape to one another and have arms that more closely approximate the triangular module 170 shown in FIG. 11. In both this and the third embodiment the neutral axis for each of the ball/socket joints is in the plane of the sheet. The construction of FIG. 12B is very similar to that of FIG. 12A, except that the FIG. 12B first modules have through holes at the point when they grip the balls of the second module.

FIG. 13 shows a fifth embodiment. In this embodiment, the two modules 180, 190 are of very different shapes. The first module 180 is ring or donut-shaped and has three spherical recesses equally spaced around its perimeter. The second module 190 is linear and has two generally spherical balls on each end, so as to be dumbbell shaped. The ball on the end of the second module 190 is adapted to fit into the spherical recess inside the first module 180 in the way shown in FIG. 13. The ball/socket joint allows movement about multiple degrees of freedom and so all the movements of the first to fourth embodiments are possible. Furthermore, extra movements are available due to the fact that there are twice as many ball/socket joints than in the first embodiment.

FIG. 14 shows two modules of a sixth embodiment of the invention. Each module has four nodes located on arms which extend perpendicularly within the plane of the sheet from a longitudinal “backbone”. The nodes extend out of the plane of the sheet. The nodes extending from arms on one end of the backbone extend in the opposite direction to the nodes of the arms at the other end of the backbone. The module is thus substantially I-shaped. In order to provide the in-plane expansion, the distance between the nodes at one end of the backbone is less than the length of the backbone minus the width of one of the arms. This allows one module to rotate by 180 degrees in-plane with respect to its neighbouring module.

FIGS. 15A and 16A show part of a sheet comprising the modules of the sixth embodiment in the closed formation. This embodiment has the advantage that the modules tessellate—that is to say they fit together leaving no gaps between them. Thus, the sheet of FIG. 15A presents a substantially flat surface that does not have any gaps or holes in it. FIG. 15B shows the sheet when it has been expanded in-plane somewhat. Each module has rotated by approximately 45 degrees with respect to its neighbour. As a result, parallelogram-shaped “holes” appear in the sheet—these are more evident in FIG. 16B.

FIGS. 15C and 16C show the sheet when each module has rotated by 90 degrees with respect to its neighbour. In this position the sheet is in its most expanded state and the sheet is twice as large as the sheet of FIG. 15A. At this point, the holes between the modules are substantially rectangular and have their maximum possible area. Continued relative rotation of the modules will result in the sheet closing back in on itself to assume its closed-up position.

FIGS. 16A and 16C show some preferred dimensions for the modules of the sheet, in millimetres.

As with the other embodiments, as well as allowing for in-plane expansion the sixth embodiment allows for out-of-plane movement so that the sheet may be conformed around non-planar shapes. To achieve this, ball/socket joints are used at the nodes which allow for some rotation about axes within the plane of the sheet when laid flat. The ball/socket joints are preferably arranged with their neutral axis being perpendicular to the plane of the sheet when laid flat. As with the other embodiments, joints other than ball/socket joints may be used, with the amount of in-plane rotation and out-of-plane rotation being selected in accordance with the desired qualities of the sheet.

FIGS. 17 and 18 illustrate more precisely how the orientation of the ball/socket joint can vary in each of the embodiments. In the first embodiment, the neutral axis is perpendicular to the plane of the sheet. This is illustrated in FIG. 17. As shown in FIG. 17, the ball and socket joint is in its “neutral” position such that the ball may rotate an equal amount in the socket in any particular direction. It will be appreciated that the ball has been inserted vertically into the socket and it should be clear that the neutral axis of the ball/socket joint in FIG. 17 is therefore vertical.

FIG. 18 shows an alternative configuration (for example that of the third, fourth and fifth embodiments) in which the ball has been inserted horizontally in the socket. Again the ball 108 is shown in its neutral position with respect to the socket 110. It will be appreciated that the neutral axis for the FIG. 18 configuration is within the plane of the sheet.

It should be noted that for both FIGS. 17 and 18 the plane of the sheet is parallel to the line X-X and is perpendicular to the page.

FIG. 19 shows a seventh embodiment of the invention. Unlike the first to sixth embodiments, this embodiment does not utilise a ball/socket joint to connect the modules together. Instead, two separate pivot joints are used. A first pivot joint 304 is intended to provide the necessary movement about an axis parallel to the plane of the sheet and a second pivot joint 306 is intended to provide the necessary movement about an axis orthogonal to the plane of the sheet.

A first module 300 of the sheet has three equi-spaced arms as shown in FIG. 19. Connected to each of the arms is a linking component 302 which is generally linear and has mutually orthogonal pivot joints at each end. The pivot connection 304 between the module 300 and the linking component 302 is such as to allow relative movement about an axis parallel to the plane of the sheet and common to both the plane of the module 300 and the linking component 302. Movement about this pivot 304 allows the sheet to be bent around objects. The linking component 302 is connected via pivot connection 306 to another linking component 302 by an axis that is perpendicular to the plane of the sheet. Relative movement about this axis allows the density of the sheet to be adjusted. As will be appreciated from FIG. 19, each module 300 is connected to three separate linking components 302 and each linking component 302 is connected at one end to a module 300 and at the other end to another linking component 302. The modules are connected together in the same repeating pattern as described above for the first to sixth embodiments so as to create the generally hexagonal “ring” structure. This can be visualised by noting that the module 300 connected via pivots 304 to three linking components 302 acts in the same way as a single module 102 of the first embodiment. That is to say, such a module 300 can move relative to other modules 300 about both axes orthogonal to and axes parallel to the plane of the flexible sheet.

Preferably, as is shown in FIG. 19, linking component 302 has a yoke that is connected to an arm of a module 300 using a roll pin to create pivot connection 304. The other end of the linking component 302 is preferably connected to a similar linking component using a clinch pin to create pivot connection 306.

As with the other embodiments, the modules can take any suitable size dependent on the application for which they will be used. Linking components 302 may have a length between the octagonal axis of 5 to 50 mm, for example 18 mm and they have a thickness of from 1 to 30 mm, for example 10 mm. As shown in FIG. 19, the width may be non-constant although is preferably in the range of from 3 to 50 mm, preferably less than 25 mm. The module 300 can have similar dimensions as the first embodiment, except that it will generally need to be much thicker so as to accommodate the pivot 304 through its thickness. In order to ensure a uniform sheet thickness, the module 300 can have the same thickness as linking component 302, for example 10 mm. The module 300 preferably has an arm length of 8 mm and an arm width of 5 mm.

The hexagonal “ring” structure is a result of using modules having three equispaced arms. If modules having other numbers of arms are used, the “ring” will be a different shape. For example, FIG. 20 shows schematically the mechanism of density change within the plane of sheet when each module 350 has four nodes 360. In this case, the “ring” is a square-shaped. For other numbers of nodes and shapes of module, the “ring” will be different shaped. Nevertheless, the “ring” will be characterised as being an area devoid of any modules.

FIG. 20A shows a configuration where all of the modules 350 are spaced by the maximum amount from their neighbours. This is the configuration of least density and greatest area. FIGS. 20B to 20D show stages in the relative movement of the modules from the most expanded state of the sheet to the most closed state of the sheet, which is shown in FIG. 20E. It will be seen that the expanded sheet has about twice the area of the unexpanded sheet. FIG. 20F shows a larger sheet part way between the expanded and unexpanded modes.

A further aspect of the present invention, in which an articulated feature may be selectively locked and unlocked, will now be described. In general, this aspect of the invention involves the use of a “locking material”, that is to say, a material that can change in some manner upon the application or removal of external energy. This change can be in the form of, for example, a phase change, a chemical change or a dimension change. The locking material is preferably located directly adjacent to certain parts of the joints of a structure so as to influence whether movement in that joint is readily possible or not.

The following examples relate to a ball/socket joint although it will be appreciated that the idea can be extended to any type of joint, for example pivot joints. In particular, the locking aspect of the invention may replace the locking systems shown in the above-discussed prior art documents (e.g. U.S. Pat. No 4,484,778).

FIG. 6 shows a cross-sectional view of a ball/socket joint. As has already been described, the ball has a flat portion 112 and the socket has a flat portion 114 so that there is a space between the end of the ball and the bottom of the socket. As the ball rotates from the position in FIG. 6 to the position in FIG. 7, the shape of this space changes. A locking material 400 can be provided in this space and will serve to prevent the rotation shown in FIGS. 6 and 7 if it is caused to be solid at any particular time. If the locking material is caused to be fluid, however, rotation will again be possible.

A preferred embodiment of locking material is a thermoplastic polymer. Such a material can be arranged to be “soft”, and therefore practically fluid, at room temperature but “frozen”, and therefore practically solid, at a lower temperature. The joints can then be locked by simply lowering their temperature. Alternatively, the thermoplastic polymer can be arranged to be practically solid at room temperature but practically fluid at a higher temperature, in which case the joints can be unlocked by raising the temperature (i.e. heating the joints or the whole structure up). It is not necessary that the thermoplastic polymer undergo a phase change in the strict sense of the word—what is required is that the viscosity of the locking material is changed to a sufficient degree such that movement is readily possible in the “unlocked” state and readily impossible in the “locked” state. Thus, it is the relative viscosity between the locked and unlocked states that matters more than whether or not a phase change has taken place.

As an alternative to, or in addition to, a “plug” of locking material inbetween the bottom of the socket and the end of the ball, locking material 400 can be applied as a thin coating around the ball and inside the socket. In order to provide the necessary locking function, grooves 402 can be disposed around the ball 108 and grooves 404 can be disposed around the socket 110 as shown in FIG. 21 to inhibit or prevent movement of the joint once the locking material is no longer sufficiently fluid. The grooves are disposed so as to be aligned with a plane perpendicular to the neutral axis of the joint. Additional or alternative grooves may however be aligned with planes parallel to the neutral axis in order to inhibit or prevent movement of the joint about the neutral axis. The shape of the grooves is not particularly important. FIG. 21 shows round profile grooves at the top and triangular profile grooves at the bottom. Of course, in a practical embodiment, the grooves will have the same profile all the way around the ball and socket. Any topographical feature may be used to achieve the locking function and grooves are not to be considered limiting. For example, pegs, dimples, bristles and surface roughness may all be used.

Referring to FIG. 6, a peg shape comprising a cylindrical recess may be formed in the socket parallel to the neutral axis 150. This peg shape may be used in either the flat-ended socket shown in FIG. 6 or in an internally spherical socket. This peg recess is filled with the locking material 400 and will serve to strengthen the prevention of rotation about all axes other than the neutral axis 150. To prevent rotation about the neutral axis, grooves aligned with planes parallel to this axis can be placed around the ball, as described above. The peg recess may alternatively be located in the ball rather than the socket and need not be aligned with the neutral axis. For example, it may be offset or aligned with some other axis.

The material defining either the ball or the socket could be the locking material 400. For example, the entire ball 108 could be made from a thermoplastic polymer that becomes fluid at high temperatures. In this state the structure may move and the shape of the ball/socket can be arranged such that movement is not possible once the temperature is lowered.

This locking concept can also be applied to other joints, such as pivot joints. As with the contact surfaces of the ball/socket joint above, the contact surfaces of the pivot or other joint can have cylindrical or polyhedral grooves recessed into them. Alternatively or additionally, flat sections can be included such that the locking material is required to be able to change shape before relative movement can occur.

All, some, or only one of the joints in a structure may be locked or unlocked by selectively introducing the energy to all, some, or only one of the joints respectively. It will usually be a simple matter to introduce energy to all the joints of a structure at the same time, making unlocking/locking very quick and simple.

The above example suggests the use of heat to heat up the locking material and make it fluid. Such heat can be provided by any known means including hot water baths, hot air guns and ovens. Further, the heat can be provided by exposure to microwaves and this option is particularly attractive for cases where it is not desired or required to heat up the actual structure of the flexible matrix. The locking material can be made of a microwave sensitive material (for example by doping a thermoplastic polymer with carbon) such that the locking material is much more susceptible to being heated up than the surrounding structure when microwaves are applied.

Some alternative locking mechanisms are schematically shown in FIGS. 22 to 27. Please note that although these Figures show ball/socket joints the locking mechanism can be applied to any type of connection between modules. Further, the concepts can be applied to single joints or multiple joints (e.g. two as shown).

FIG. 22 shows an example of thermo-mechanically induced shape change. In this example, the ball 108 is made from a material having a low thermal expansion coefficient, the locking material 400 has a high thermal expansion coefficient and the socket 110 has a medium thermal expansion coefficient. When heat is applied, the locking material will expand the most, the ball will expand the least and the socket will expand by an amount intermediate the two. A force will therefore be established between the ball and the socket as a result of this expansion which tends to increase friction both between the locking material and the socket and between the locking material and the ball. This in turn serves to prevent practical rotation of the ball in the socket. As is shown in FIG. 22, the necessary heat can be provided by an element running through the locking material, powered by a wire through the whole structure.

FIG. 23 shows an example of an electromechanical induced shape change. In this case, a piezo-electric or other electro-reactive material is used as the locking material 400. In the relaxed state, both the ball 108 and the locking material have interlocking grooves or corrugations such that relative rotation is prevented. Upon the provision of an electric current, the piezo-electric locking material can be made to move in such a way that the grooves or corrugations are disengaged and it becomes possible for the ball 108 to move in the socket 110.

FIG. 24 shows the use of an electro-or magneto-rheological fluid 420 in the socket 110 which can clamp and inhibit or prevent a paddle on a rod moving through a fluid within the module. As is seen in FIG. 24, each of the balls 108 is provided with at least one (two in FIG. 24) paddle 410. When the electro-rheological fluid 420 is in its fluid state (which is usually its resting state) the balls can rotate because the paddles 410 can move through the fluid 420 (albeit with some practically insignificant resistance). When an electric current is applied to the electro-rheological fluid 420 it effectively “freezes” and it is no longer practically possible for the paddles 410 to move, thereby clamping the balls 108 in place and locking the structure.

FIG. 25 shows an example of chemical-mechanical locking. In this case an adhesive cross-linking locking material 402 is used inbetween the ball 108 and socket 110. The locking material preferably has reversible adhesive bonds and can be used in conjunction with an piezo-electric material 404 as shown in FIG. 25. The piezo-electric material 404 can be arranged to vibrate at a frequency sufficient to excite the adhesive 402 molecules, thereby raising their temperature and causing the adhesive 402 to cure. The effect can be temporary or permanent, depending on the materials used.

FIG. 26 shows an example of pneumatic-mechanical locking. As is shown in FIG. 26, the ball 108 is made from a porous material that has quite a high resistance to fluid flow. The application of pressurised air to the ball 108 will therefore serve to expand it creating a frictional fit of the ball 108 in the socket 110. This tends to lock the ball in place. Air can be extracted, or allowed to leak away, from the ball to contract it and allow movement once again. Alternatively, the ball can be manufactured with an interference fit in the socket and air can be extracted away to allow movement.

FIG. 27 shows an example of hydraulic-mechanical locking. In this case, the socket material 110 is made porous and is caused to expand by the provision of a pressurised liquid thereto. As is shown in FIG. 27 such expansion serves to clamp the socket 110 against the ball 108 so as to lock movement.

An alternative to the FIG. 24 embodiment is to use a thixotrophic or rheopectic fluid in the socket 110. When a thixotrophic fluid is used, the fluid will more viscous under low sheer stress (locked) and will be less viscous under higher sheer stress (unlocked). Thus, the structure will appear to be locked when low forces are applied to it but will appear to be unlocked under high force. This is useful for structures that are designed to crush under certain forces.

A rheopectic fluid performs the opposite function in that the fluid will be more viscous under high sheer stress (locked) and will be less viscous under low sheer stress (unlocked). This provides a particularly promising shock-proof structure because the structure is more resistant to high forces than low forces. Thus, a structure which is flexible under normal use but which stiffens up under a shock can be provided.

For all the embodiments of locking, reversibility can be provided or not according to the circumstances. For some applications, it may only be necessary to unlock or lock the structure once and in that case reversibility of locking is not a prerequisite. However, many of the above embodiments allow reversible structures to be provided, thereby making the structure reusable. Reversibility is provided by providing for the locking material to be able to change back and forth between states (solid/fluid, expanded/compressed, sticky/non sticky etc.) a plurality of times.

A combination of reversible and non-reversible locking mechanisms may be used in the same structure. Thus, a UV-curable adhesive can be applied to the all/socket interface together with one of the reversible locking materials (e.g. a thermoplastic polymer). The resulting structure can be heated up to fluidise the thermoplastic locking material and render the joints moveable so that the structure can be shaped into position. The structure can then be cooled down somewhat so as substantially to tighten the structure but still allow some movement, albeit with frictional resistance. Then, finally to lock the structure in place once any fine changes have been made, a UV light can be switched on so as to cure the adhesive and permanently lock the structure. This has the advantage that further increases in temperature do not render the structure flexible again. The modules can be made transparent so as to allow the UV light to reach the curable adhesive.

In the above described embodiments, activation of the active material in the joint makes the joint flexible for a given time period until the activation energy is dissipated. For example, heating of the active material can allow the joint to move for a limited amount of time until the joint cools down. Rather than allowing or preventing movement, the active material can additionally or alternatively be used to provide a bonding or debonding function. Such joints can be designed having active material which possesses bonding or de-bonding properties when activated. For example, a joint can be designed which bonds two or more materials together and which, upon the introduction of energy, de-bonds the two materials. The converse is also possible whereby the active material does not bond the two materials together until energy is introduced, at which point bonding is created. As with all of the embodiments of the invention, this is applicable to more than just ball/socket joints and the active material can be used, for example, as the filling in a sandwich like structure which bonds together two planar materials. Pressure can be used to activate the material such that a bond between the two layers is created when pressure is applied.

Any of the locking mechanisms may be applied to any of the herein described articulated structures. The locking mechanisms may also be applied to prior art structures, including flexible sheets.

FIG. 28 shows a particularly promising application of the present technology—a spinal brace. These braces provide support to spines which are deformed and are usually in service for 1 to 2 years. They undergo varying and often cyclical loads. Such braces have traditionally been made from a solid piece of high density polyethylene material that is heated up to 160° C. to render it flexible and shaped around a model whilst in this flexible position. This has the disadvantage that a mould of the patient's body is required to be taken so as to create the model before the brace can be fitted. This makes the process of fitting the brace slow and expensive.

In FIG. 28, the flexible sheet structure is shown inside two “skins” of flexible material. The cut away portion in the Figure shows part of the top skin cut away revealing the sheet structure skeleton and the inner skin behind that. The skin allows the brace to be used against sensitive body parts without causing discomfort or irritation. As an alternative to using skins, once the flexible structure is locked in position, a gel, foam or other fluid can be poured over the flexible structure so as to encapsulate it. Polyurethane or polypropylene foam can be used. If this fluid is allowed to set hard, this provides further rigidity to the structure to make a permanent spinal brace. Alternatively, the gel can be arranged to set but still remain flexible. In this case a spinal brace having a continuous surface can be provided but which can still be adjusted by unlocking the modules in any of the ways described above. The coatings and coverings can be used with any of the structures disclosed herein and for any application (not just spinal braces).

The use of the present invention in a spinal brace is advantageous for a number of reasons including the three detailed below.

1. The high conformability of the flexible sheet structure at low temperatures means that an initially flat sheet can be conformed directly around a patient's body without the need to make moulds and models and with no need to remove or add any new modules. This means that a supply of flat rectangular sheets can be kept by the physician and any one can be used on any patient. Once the sheet has been conformed into position, it can be locked simply and quickly without having to undergo a laborious module-by-module locking procedure. For example, a flat sheet can be blasted with a hot air gun in order to make it flexible, can be moulded around the patient's body while still in the flexible mode, and can be allowed to cool down naturally so as to become rigid and perform a spinal support function. This can all be done in a very short space of time, with a standard initial flat sheet and without any laborious and tedious tightening or untightening steps.

2. The resulting brace will last for many years and, if any adjustments are required (as will be the case for braces for children), they can be made quickly and easily. Further the brace material is clean and safe and poses no health risk to the patient. The brace is also sufficiently rigid to bear the loads required and will remain in shape once locked.

3. To increase comfort, the flexible structure may be padded, covered or cushioned so that the flexible structure acts as a conformable endoskeleton.

In general, any of the flexible structures described in this application may be modified so as to have a continuous surface across a whole or part of their surface. This can be achieved by encapsulating the “skeleton” structure with one or two skins laid over and adhered to the skeleton or by embedding the skeleton in some type of fluid which is then allowed to become solid. This fluid may take the form of a foam or gel. Combinations of these two methods may be used whereby the gaps between the modules are filled with a foam or gel and the resulting structure is covered by a skin. Where skins are not used, the surface may be smoothed by sanding or the like to provide a smooth continuous surface. The exact method used will depend on its suitability for the intended application. It is thought that these methods are particularly applicable for uses as shock absorbent padding or aerodynamic wind-proof or hydrodynamic water-proof shapes (e.g. wings and boat hulls).

The structure of the present invention may be used in other applications, for example, for handling delicate objects or for rapid custom moulding processes. The structure can be scaled up or down and used for collapsible and reusable shelters.

Other possible applications (which are not to be regarded as limiting the present invention) include:—

Aerospace and Defence:—

Space suits; Hazard suits; Body armour and protection; Repair kits; Filled structures; Medical casualty support; Aircraft wing containment of fuel; Internal and external aerofoil and fairings; Fuel tanks; Wings: Parachutes, Microlights, Hangliders.

Marine

Diving suits; Boats, canoes, paddles; Nets for trapping fish or submarines; Rigid sails.

Construction and Architecture

Emergency Buildings; Marquees, refugee, disaster relief accommodation; Acoustic structures for auditoriums; Modelling materials; Land stabilisation; Landscaping, trellis, fencing, pond liners; Ornamental and curved structures; Furniture and seats; Re-usable and collapsible structures; Wave power electricity generation; Scaffolding; Tunnel reinforcing; DIY—base for curved structures; Shape, model and fix material; Sculptures; Dome buildings; Pipe construction and repair; Exhibition standards; Shop displays; Structures in tricky places; Irrigation, heating or cooling jackets—small tubes; Artistic and architectural base for sculptures.

Automotive

Vehicle design and modelling; Soft-top and hard-top convertibles; Custom seating; Impact absorbing structures including air bag replacement; Easy to recycle automotive components; Snap/unsnap technology; Lorries—alternative to cargo nets; Crash dummies; Snow tyres.

Apparel & Accessories

Body protection; Hats and helmets; Footwear; Disco-gear; Jewellery—necklaces and bracelets; Fashion accessories; Interfacing material; Heated-cooled jacket via micro piping; Mannequins and shop displays; Ladies underwear—corsets, bras, bustles.

Toys and Novelties

Action figures and dolls; General modelling material; A construction toy in its basic form; Stress relievers; 3D jigsaw.

Sport and Leisure

Light, rigid structures: Windsurfers, skateboards, snow boards, skis, Ski boots, sledges; Sports body protection: Cricket box, fencing, baseball glove, pads and padding, boxers, motorcycling, crash helmets, ice hockey protection; Tents, shelters and survival equipment for climbers and hikers, Construction of suitcases and holdalls, Leather saddles—structure

Medical

Orthotics; Strengthening weakened limbs; Neck braces; Wrist supports; Plaster casts; First aid (chemical or epoxy fixing); Stretcher; Move as found, body, immobilisation/splints; Clamps to hold head for X-ray; Wheel chairs; Bed support for prevention of pressure sores; Modelling of: limbs, shoe insoles; Rice paddy-bed shoes; Micro-level reconstructive surgery; locking body joint, limit joint flexibility, fix range and direction of motion; Medical measurements—heart rate, breathing; Operating tables/patient positioning; Drug release

Electronics and Telecomms

Backing for curved/shaped LCD type thin displays; 3D shape transmission sensor; Platform for wearable electronics including mobile phones, GSM computers; Shaped phones for hands free; Collapsible satellite dish; Telecomms masts, temporary, collapsible, pre-fabricated; Faraday cage & general EMI/RFI screening, Phone boxes and acoustic hoods/shelters.

Oil and Gas

Pipeline repair kits; Oil spillage containment; Tunnelling structural support.

Packaging

Specialist packaging; Delicate artefacts packaging

1. A flexible sheet structure comprising a plurality of modules connected together, said plurality of modules being connected together so that each module is capable of rotating about first and second axes with respect to a neighbouring module to which it is connected, said first axis being parallel to the plane of the sheet when laid flat and said second axis being orthogonal to the plane of the sheet when laid flat.

2. A flexible sheet structure according to claim 1, wherein a module can rotate relative to a neighbouring module to which it is connected about said axis parallel to the plane of the sheet when laid flat through at least the full range of −10° to +10°.

3. A flexible sheet structure according to claim 2, wherein said rotation is at least through the full range of −20° to +20°.

4. A flexible sheet structure according to claim 3, wherein a module can rotate relative to a neighbouring module to which it is connected about said axis parallel to the plane of the sheet when laid flat by between no more than −60° and no more than +60°.

5. A flexible sheet structure according to claim 4, wherein said rotation is between no more than −30° and no more than +30°.

6. A flexible sheet structure according to claim 1, wherein a module can rotate relative to a neighbouring module to which it is connected about said axis orthogonal to the plane of the sheet when laid flat through at least the full range of −10° to +10°.

7. A flexible sheet structure according to claim 6, wherein said rotation is at least through the full range of −30° to +30°.

8. A flexible sheet structure according to claim 7, wherein said rotation is at least through the full range of −80° to +80°.

9. A flexible sheet structure according to claim 1, wherein each module has a plurality of nodes and at least one of said modules has each of its plurality of nodes connected to a node of a different neighbouring module.

10. A flexible sheet structure according to claim 9, wherein each module has 3 and only 3 nodes.

11. A flexible sheet structure according to claim 9, wherein each module has 4 and only 4 nodes.

12. A flexible sheet structure according to claim 10, wherein each node is located at the end of an arm.

13. A flexible sheet structure according to claim 12, wherein each arm of the module lies parallel to the plane of the sheet when laid flat.

14. A flexible sheet structure according to claim 9, wherein each nodal connection is a single joint that allows both said rotation orthogonal to the plane of the sheet when laid flat and said rotation parallel to the plane of the sheet when laid flat, preferably simultaneously such that rotation about a single axis intermediate said orthogonal and parallel axes is possible.

15. A flexible sheet structure according to claim 14, wherein said single joint has a neutral axis oriented at substantially 90° to the plane of the sheet when laid flat.

16. A flexible sheet structure according to claim 14, wherein said single joint has a neutral axis oriented at an angle to the plane of the sheet when laid flat.

17. A flexible sheet structure according to claim 14, wherein said single joint has a neutral axis oriented substantially parallel to the plane of the sheet when laid flat.

18. A flexible sheet structure according to claim 14, wherein said single joint is a ball/socket joint.

19. A flexible sheet structure according to claim 18, wherein said ball/socket joint is a double ended ball/socket joint comprising two balls and two sockets.

20. A flexible sheet structure according to claim 1, wherein a module can rotate relative to a neighbouring module to which it is directly or indirectly connected about said axis parallel to the plane of the sheet when laid flat by between at least the full range of −90° to +90°.

21. A flexible sheet structure according to claim 20, wherein a module can rotate relative to a neighbouring module to which it is directly or indirectly connected about said axis parallel to the plane of the sheet when laid flat by between at least the full range of −180° to +180°.

22. A flexible sheet structure according to claim 20, wherein a module can rotate relative to a neighbouring module to which it is directly or indirectly connected about said axis orthogonal to the plane of the sheet when laid flat by at least between −100° and +100°.

23. A flexible sheet structure according to claim 22, wherein a module can rotate relative to a neighbouring module to which it is directly or indirectly connected about said axis parallel to the plane of the sheet when laid flat by between no more than −120° and no more than +120°.

24. A flexible sheet structure according to claim 1, wherein at least one module of said sheet is connected to a neighbouring module via a linking component.

25. A flexible sheet structure according to claim 24, wherein said at least one module is connected to said linking component by a joint which allows relative rotation between the module and linking component about said axis parallel to the plane of the sheet when laid flat.

26. A flexible sheet structure according to claim 25, wherein said linking component comprises two members connected together by a joint which allows relative rotation between the two members about an axis orthogonal to the plane of the sheet when laid flat.

27. A flexible sheet structure according to claim 24, wherein each module is connected to a linking component by a joint which allows relative rotation between the module and the linking component about said axis orthogonal to the plane of the sheet when laid flat.

28. A flexible sheet structure according to claim 24, wherein said linking component is a single linear member having a ball at each end thereof.

29. A flexible sheet structure according to claim 1, wherein the modules and optional linking components are connected together so as to form a regular pattern of closed loops in said plane.

30. A flexible sheet structure according to claim 29, wherein the loops can close in to reduce in area while the sheet remains flat due to relative rotation of modules about said axis orthogonal to the plane of the sheet when laid flat.

31. A flexible sheet structure according to claim 1, wherein the effective area of the whole or part of the sheet can be varied while the sheet remains flat.

32. A flexible sheet structure according to claim 31, wherein the area of said sheet can be reduced to 80% or less of its original size, while remaining flat.

33. A flexible sheet structure according to claim 31, wherein the area of said sheet can be reduced to 60% or less of its original size, while remaining flat.

34. A flexible sheet structure according to claim 34, wherein the area of said sheet can be reduced to 40% or less of its original size, while remaining flat.

35. A flexible sheet structure according to claim 1, wherein each module is capable of rotating relative to a neighbouring module to which it is connected about each of the mutually orthogonal axes that lie in the plane of the sheet when laid flat.

36. A flexible sheet structure according to claim 9, wherein each module is connected to a plurality of neighbouring modules.

37. A flexible sheet structure comprising a plurality of modules connected together, at least one of said modules being connected to another said module by a multiple degree of freedom joint that has a neutral axis oriented substantially at 90° to the plane of the sheet when laid flat.

38. A flexible sheet structure according to claim 37, wherein each said module of the sheet is connected to another module by a multiple degree of freedom joint that has a neutral axis oriented substantially at 90° to the plane of the sheet when laid flat.

39. A flexible sheet structure comprising a plurality of first and second connected components, each said first component being connected to a said second component by a joint that allows for relative rotation about an axis parallel to the plane of the sheet when flat and each said second component being connected to a neighbouring said second component by a joint that allows for relative rotation about an axis orthogonal to the plane of the sheet when flat.

40. A flexible sheet structure according to claim 39, wherein each first component has three arms spaced by about 120° in the plane of the sheet when laid flat and each second component is a linear member having said joints disposed at each end thereof.

41. A flexible sheet structure comprising a plurality of modules connected together, each of said modules having first, second and third arms, each of said arms being regularly spaced from the other two said arms, each said arm being connected to an arm of a neighbouring said module so that each module of the sheet is capable of rotating with respect to its neighbouring module about an axis orthogonal to the plane of the sheet when laid flat.

42. A flexible sheet structure according to claim 1, wherein each module is constructed of substantially rigid and non-flexible plastics material.

43. A flexible sheet structure according to claim 1, wherein the connections between modules are arranged such that pure relative translation between neighbouring modules is not possible.

44. A flexible sheet structure according to claim 1, wherein each module in the sheet is substantially similar in shape to the other modules of the sheet.

45. A flexible street structure comprising a plurality of modules connected together, said plurality of modules being connected together so as to allow the effective area of the sheet to be varied while the sheet remains flat and to allow out of plane movement so that the sheet may be smoothly conformed around complex shapes.

46. A flexible sheet structure according to claim 1, further comprising additional material applied so as to give a smooth outer surface for said sheet structure.

47. A flexible sheet structure according to claim 46, wherein said additional material is a thin covering material adhered to the plurality of modules.

48. A flexible sheet structure according to claim 46, wherein said additional material is applied as a fluid so as to encapsulate the plurality of modules.

49. A module for use in the flexible sheet structure of claim 1.

50. A module for use in a flexible sheet structure, said module having arms each comprising one half of a multiple degree of freedom joint, for connection with the other half of the multiple degree of freedom joint located on an arm of a neighbouring module in the sheet, said multiple degree of freedom joint half being oriented such that the resulting multiple degree of freedom joint will have a neutral axis oriented out of the plane of the sheet when flat.

51. A module according to claim 50, wherein said multiple degree of freedom joint half is oriented at 90° to the major plane of the module.

52. A module according to claim 51, wherein said multiple degree of freedom joint half is one of a ball and a socket.

53. A lockable articulated structure comprising a plurality of modules connected together so that said modules are selectively moveable with respect to one another, at least one connection between two said modules comprising a locking material capable of assuming at least two states, said at least two states including a first state which allows relative movement of said components and a second state which at least substantially prevents such movement, a transition between said two states being accomplished by the selective introduction of energy to said locking material.

54. A structure according to claim 53, wherein said selective movement is rotation.

55. A structure according to claim 54, wherein said rotation is about more than one axis.

56. A structure according to claim 53, wherein said first state is a softer state than said second state.

57. A structure according to claim 56, wherein said second state is a frozen state.

58. A structure according to claim 57, wherein said transition is from said frozen state to said soft state and is accomplished by providing heat to said locking material.

59. A structure according to claim 58, wherein said locking material is susceptible of being heated by microwave energy to a greater extent than the material of the articulated structure such that heat may be provided to said locking material by subjecting the whole structure to microwave radiation.

60. A structure according to claim 53, wherein said first state is an expanded state and said second state is a compressed state.

61. A structure according to claim 53, wherein said first state is a compressed state and said second state is an expanded state.

62. A structure according to claim 60, wherein said transition is from said compressed state to said expanded state and is accomplished by providing heat or electricity to said locking material.

63. A structure according to claim 53, wherein said first state is a non-adhered state and said second state is an adhered state.

64. A structure according to claim 63, wherein said transition is from said non-adhered state to said adhered state and is accomplished by providing heat, UV radiation or electricity to said connection.

65. A structure according to claim 53, wherein said first state is a pressurised state and said second state is a unpressurised or less pressurised state.

66. A structure according to claim 65, wherein said transition is from said unpressurised or less pressurised state to said pressurised state and is accomplished by pumping a hydraulic or pneumatic fluid through said connection.

67. A structure according to claim 53, wherein said transition is reversible.

68. A structure according to claim 53, wherein said connection is a ball-socket joint and said locking material is disposed at least partly around the ball.

69. A structure according to claim 68, wherein said ball and/or socket has a flat portion and said locking material is located adjacent said flat portion.

70. A structure according to claim 68, wherein there are provided topographical features that prevent rotation about the neutral axis of said ball/socket joint when said structure is locked.

71. A structure according to claim 70, wherein said ball or socket has one or more groove-shaped topographical features in which said locking material is located.

72. A structure according to claim 53, wherein said connection is a pivot comprising a shaft part and an annular part.

73. A structure according to claim 72, wherein said locking material is located between said shaft part and said annular part.

74. A structure according to claim 73, wherein said shaft or annular part has a non-cylindrical face and said locking material is located adjacent said face.

75. A structure according to claim 53, wherein said material is a thermoplastic material.

76. A structure according to claim 53, wherein said material is a eutectic material.

77. A structure according to claim 53, wherein said material is a thermosetting material.

78. A structure according to claim 53, where said material is a polymer.

79. A structure according to claim 53, wherein said material is a thixotrophic fluid or a rheopectic fluid so as to provide differing amounts of effective viscosity according to the level of force acting on the structure.

80. A flexible sheet structure comprising the lockable articulated structure of claim 53.

81-82. (canceled)

83. A spinal brace comprising the flexible sheet structure of any one of claim 1.
